(19) United States
(12) Patent Application Publication
(10) Pub. No.: US 2011/0317757 A1
(43) Pub. Date: Dec. 29, 2011

(54) INTRA PREDICTION MODE SIGNALING FOR FINER SPATIAL PREDICTION DIRECTIONS

(75) Inventors: Muhammed Z. Coban, San Diego, CA (US); Marta Karczewicz, San Diego, CA (US)

(73) Assignee: QUALCOMM Incorporated, San Diego, CA (US)

(21) Appl. No.: 13/166,713

(22) Filed: Jun. 22, 2011

Related U.S. Application Data
(60) Provisional application No. 61/358,601, filed on Jun. 25, 2010.

(51) Int. Cl. H04N 7/32; H04N 7/26

(52) U.S. Cl. 375/240.02; 375/E07.126; 375/E07.243; 375/E07.144

(57) ABSTRACT

A video encoder selects a prediction mode for a current video block from a plurality of prediction modes that includes both main modes and finer directional intra spatial prediction modes, also referred to as non-main modes. The video encoder may be configured to encode the selection of the prediction mode of the current video block based on prediction modes of one or more previously encoded video blocks of the series of video blocks. The selection of a non-main mode can be coded as a combination of a main mode and a refinement to that main mode. A video decoder may also be configured to perform the reciprocal decoding function of the encoding performed by the video encoder. Thus, the video decoder uses similar techniques to decode the prediction mode for use in generating a prediction block for the video block.

This application claims the benefit of U.S. Provisional Application No. 61/358,601, filed Jun. 25, 2010, the entire contents of which are incorporated herein by reference.

### TECHNICAL FIELD

This disclosure relates to digital video coding and, more particularly, to coding of intra prediction modes for video blocks.

### BACKGROUND

Digital video capabilities can be incorporated into a wide range of devices, including digital televisions, digital direct broadcast systems, wireless communication devices such as radio telephone handsets, wireless broadcast systems, personal digital assistants (PDAs), laptop computers, desktop computers, tablet computers, digital cameras, digital recording devices, video gaming devices, video game consoles, and the like. Digital video devices implement video compression techniques, such as MPEG-2, MPEG-4, or ITU-T H.264/MPEG-4, Part 10, Advanced Video Coding (AVC), to transmit and receive digital video more efficiently. Video compression techniques perform spatial and temporal prediction to reduce or remove redundancy inherent in video sequences. New video standards, such as the High Efficiency Video Coding (HEVC) standard being developed by the “Joint Collaborative Team—Video Coding” (JCTVC), which is a collaboration between MPEG and ITU-T, continue to emerge and evolve. This new HEVC standard is also sometimes referred to as H.265.

Block-based video compression techniques may perform spatial prediction and/or temporal prediction. Intra-coding relies on spatial prediction to reduce or remove spatial redundancy between video blocks within a given unit of coded video, which may comprise a video frame, a slice of a video frame, or the like. In contrast, inter-coding relies on temporal prediction to reduce or remove temporal redundancy between video blocks of successive coded units of a video sequence. For intra-coding, a video encoder performs spatial prediction to compress data based on other data within the same unit of coded video. For inter-coding, the video encoder performs motion estimation and motion compensation to track the movement of corresponding video blocks of two or more adjacent units of coded video.

A coded video block may be represented by prediction information that can be used to create or identify a predictive block, and a residual block of data indicative of differences between the block being coded and the predictive block. In the case of inter-coding, one or more motion vectors are used to identify the predictive block of data from a previous or subsequent coded unit, while in the case of intra-coding, the prediction mode can be used to generate the predictive block based on data within the coded unit associated with the video block being coded. Both intra-coding and inter-coding may define several different prediction modes, which may define different block sizes and/or prediction techniques used in the coding. Additional types of syntax elements may also be included as part of encoded video data in order to control or define the coding techniques or parameters used in the coding process.

After block-based prediction coding, the video encoder may apply transform, quantization and entropy coding processes to further reduce the bit rate associated with communication of a residual block. Transform techniques may comprise discrete cosine transforms (DCTs) or conceptually similar processes, such as wavelet transforms, integer transforms, or other types of transforms. In a discrete cosine transform process, as an example, the transform process converts a set of pixel values into transform coefficients, which may represent the energy of the pixel values in the frequency domain. Quantization is applied to the transform coefficients, and generally involves a process that limits the number of bits associated with any given transform coefficient. Entropy coding comprises one or more processes that collectively compress a sequence of quantized transform coefficients. Examples of entropy coding techniques include context adaptive variable length coding (CAVLC) and context adaptive binary arithmetic coding (CABAC), although other entropy coding techniques also exist.

Filtering of video blocks may be applied as part of the encoding and decoding loops, or as part of a post-filtering process on reconstructed video blocks. Filtering is commonly used, for example, to reduce blockiness or other artifacts common to block-based video coding. Filter coefficients (sometimes called filter taps) may be defined or selected in order to promote desirable levels of video block filtering that can reduce blockiness and/or improve the video quality in other ways. A set of filter coefficients, for example, may define how filtering is applied along edges of video blocks or other locations within video blocks. Different filter coefficients may cause different levels of filtering with respect to different pixels of the video blocks. Filtering, for example, may smooth or sharpen differences in intensity of adjacent pixel values in order to help eliminate unwanted artifacts.

### SUMMARY

This disclosure describes techniques for signaling the prediction mode used for a current video block. In particular, this disclosure describes a video encoder configured to select a prediction mode for a current video block from a plurality of prediction modes that includes both main modes and finer directional intra spatial prediction modes, also referred to as non-main modes. The video encoder may be configured to encode the selection of the prediction mode of the current video block based on prediction modes of one or more previously encoded video blocks of the series of video blocks. The selection of a non-main mode can be coded as a combination of a main mode and a refinement to that main mode. A video decoder may also be configured to perform the reciprocal decoding process relative to the encoding process performed by the video encoder. Thus, the video decoder may use similar techniques to decode the prediction mode used in generating a prediction block for an encoded video block.

In one aspect, a method of decoding a video block includes identifying a first prediction mode for a first neighboring block of the video block, wherein the first prediction mode is one of a set of prediction modes; identifying a second prediction mode for a second neighboring block of the video block, wherein the second prediction mode is one of the set of prediction modes; based on the first prediction mode and the second prediction mode, identifying a most probable prediction mode for the video block, wherein the most probable prediction mode is one of a set of main modes and the set of main modes is a sub-set of the set of prediction modes; in response to receiving a first syntax element, generating a prediction block for the video using the most probable mode; and, in response to receiving a second syntax element, identifying an actual prediction mode for the video block based on a third syntax element and a fourth syntax element, wherein the third syntax element identifies a main mode and the fourth syntax element identifies a refinement to the main mode.

In another aspect a method of encoding a video block includes identifying a first prediction mode for a first neighboring block of the video block, wherein the first prediction mode is one of a set of prediction modes; identifying a second prediction mode for a second neighboring block of the video block, wherein the second prediction mode is one of the set of prediction modes; based on the first prediction mode and the second prediction mode, identifying a most probable prediction mode for the video block, wherein the most probable prediction mode is one of a set of main modes and the set of main modes is a sub-set of the set of prediction modes; identifying an actual prediction mode for the video block; in response to the actual prediction mode being the same as the most probable prediction mode, transmitting a first syntax element indicating that the actual mode is the same as the most probable mode; and, in response to the actual mode not being the same as the most probable prediction mode, transmitting a second syntax element indicating a main mode and a third syntax element indicating a refinement to the main mode, wherein the main mode and the refinement to the main mode correspond to the actual prediction mode.

In another aspect, a video decoder includes a prediction unit to identify a first prediction mode for a first neighboring block of the video block, wherein the first prediction mode is one of a set of prediction modes; identify a second prediction mode for a second neighboring block of the video block, wherein the second prediction mode is one of the set of prediction modes; based on the first prediction mode and the second prediction mode, identify a most probable prediction mode for the video block, wherein the most probable prediction mode is one of a set of main modes and the set of main modes is a sub-set of the set of prediction modes; in response to receiving a first syntax element, identify the most probable mode as the actual prediction mode; in response to receiving a second syntax element, identify an actual prediction mode for the video block based on a third syntax element and a fourth syntax element, wherein the third syntax element identifies a main mode and the fourth syntax element identifies a refinement to the main mode; generate a prediction block for the video block using the actual prediction mode.

In another aspect, a video encoder includes a prediction unit to determine an actual prediction mode for a video block; identify a first prediction mode for a first neighboring block of the video block, wherein the first prediction mode is one of a set of prediction modes; identify a second prediction mode for a second neighboring block of the video block, wherein the second prediction mode is one of the set of prediction modes; based on the first prediction mode and the second prediction mode, identify a most probable prediction mode for the video block, wherein the most probable prediction mode is one of a set of main modes and the set of main modes is a sub-set of the set of prediction modes; in response to the actual prediction mode being the same as the most probable prediction mode, generating a first syntax element indicating that the actual mode is the same as the most probable mode; in response to the actual mode not being the same as the most probable prediction mode, generating a second syntax element indicating a main mode and a third syntax element indicating a refinement to the main mode, wherein the main mode and the refinement to the main mode correspond to the actual prediction mode.

In another aspect, an apparatus for decoding video data includes means for identifying a first prediction mode for a first neighboring block of the video block, wherein the first prediction mode is one of a set of prediction modes; means for identifying a second prediction mode for a second neighboring block of the video block, wherein the second prediction mode is one of the set of prediction modes; means for identifying a most probable prediction mode for the video block based on the first prediction mode and the second prediction mode, wherein the most probable prediction mode is one of a set of main modes and the set of main modes is a sub-set of the set of prediction modes; means for generating a prediction block for the video using the most probable mode in response to receiving a first syntax element; and, means for identifying, in response to receiving a second syntax element, an actual prediction mode for the video block based on a third syntax element and a fourth syntax element, wherein the third syntax element identifies a main mode and the fourth syntax element identifies a refinement to the main mode.

In another aspect, an apparatus for encoding video data includes means for identifying a first prediction mode for a first neighboring block of the video block, wherein the first prediction mode is one of a set of prediction modes; means for identifying a second prediction mode for a second neighboring block of the video block, wherein the second prediction mode is one of the set of prediction modes; means for identifying a most probable prediction mode for the video block based on the first prediction mode and the second prediction mode, wherein the most probable prediction mode is one of a set of main modes and the set of main modes is a sub-set of the set of prediction modes; means for identifying an actual prediction mode for the video block; means for transmitting a first syntax element indicating that the actual mode is the same as the most probable mode in response to the actual prediction mode being the same as the most probable prediction mode; and, means for transmitting a second syntax element indicating a main mode and a third syntax element indicating a refinement to the main mode in response to the actual mode not being the same as the most probable prediction mode, wherein the main mode and the refinement to the main mode correspond to the actual prediction mode.

The techniques described in this disclosure may be implemented in hardware, software, firmware, or any combination thereof. If implemented in software, the software may be executed in a processor, which may refer to one or more processors, such as a microprocessor, application specific integrated circuit (ASIC), field programmable gate array (FPGA), or digital signal processor (DSP), or other equivalent integrated or discrete logic circuitry. Software comprising instructions to execute the techniques may be initially stored in a computer-readable medium and loaded and executed by a processor.

Accordingly, this disclosure also contemplates a computer program product comprising a computer-readable storage medium having stored thereon instructions that, when executed, cause one or more processors of a device for decoding video data to identify a first prediction mode for a first neighboring block of the video block, wherein the first prediction mode is one of a set of prediction modes; identify a second prediction mode for a second neighboring block of the video block, wherein the second prediction mode is one of the set of prediction modes; based on the first prediction mode and the second prediction mode, identify a most probable prediction mode for the video block, wherein the most probable prediction mode is one of a set of main modes and the set of main modes is a sub-set of the set of prediction modes; in response to receiving a first syntax element, generate a prediction block for the video using the most probable mode; and, in response to receiving a second syntax element, identify an actual prediction mode for the video block based on a third syntax element and a fourth syntax element, wherein the third syntax element identifies a main mode and the fourth syntax element identifies a refinement to the main mode.

Additionally, this disclosure also contemplates a computer program product comprising a computer-readable storage medium having stored thereon instructions that, when executed, cause one or more processors of a device for encoding video data to identify a first prediction mode for a first neighboring block of the video block, wherein the first prediction mode is one of a set of prediction modes; identify a second prediction mode for a second neighboring block of the video block, wherein the second prediction mode is one of the set of prediction modes; based on the first prediction mode and the second prediction mode, identify a most probable prediction mode for the video block, wherein the most probable prediction mode is one of a set of main modes and the set of main modes is a sub-set of the set of prediction modes; identify an actual prediction mode for the video block; in response to the actual prediction mode being the same as the most probable prediction mode, transmit a first syntax element indicating that the actual mode is the same as the most probable mode; in response to the actual mode not being the same as the most probable prediction mode, transmit a second syntax element indicating a main mode and a third syntax element indicating a refinement to the main mode, wherein the main mode and the refinement to the main mode correspond to the actual prediction mode.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating a video encoding and decoding system that performs the coding techniques described in this disclosure.

FIGS. 2A and 2B are conceptual diagrams illustrating an example of quadtree partitioning applied to a largest coding unit (LCU).

FIG. 3 is a block diagram illustrating an example of the video encoder of FIG. 1 in further detail.

FIG. 4 is a conceptual diagram illustrating a graph that depicts an example set of prediction directions associated with various intra-prediction modes.

FIG. 5 is a conceptual diagram illustrating various intra-prediction modes of ITU-T H.264/AVC, which may correspond to main modes in this disclosure.

FIG. 6 is a block diagram illustrating an example of the video decoder of FIG. 1 in further detail.

FIG. 7 is a flowchart showing a video encoding method implementing techniques described in this disclosure.

FIG. 8 is a flowchart showing a video decoding method implementing techniques described in this disclosure.

### DETAILED DESCRIPTION

This disclosure describes techniques for signaling the prediction mode used for a current video block. In particular, the techniques of this disclosure include a video encoder selecting a prediction mode for a current video block from a plurality of prediction modes that includes both main modes and finer directional intra spatial prediction modes, also referred to as non-main modes. The video encoder may be configured to encode the selection of the prediction mode of the current video block based on prediction modes of one or more previously encoded video blocks of the series of video blocks. The selection of a non-main mode can be coded as a combination of a main mode and a refinement to that main mode. A video decoder may also be configured to perform the reciprocal decoding function of the encoding performed by the video encoder. Thus, the video decoder uses similar techniques to decode the prediction mode for use in generating a prediction block for the video block. The techniques of this disclosure, in some instances, may improve the quality of reconstructed video by using a larger number of possible prediction modes, while also minimizing the bit overhead associated with signaling for this larger number of prediction modes.

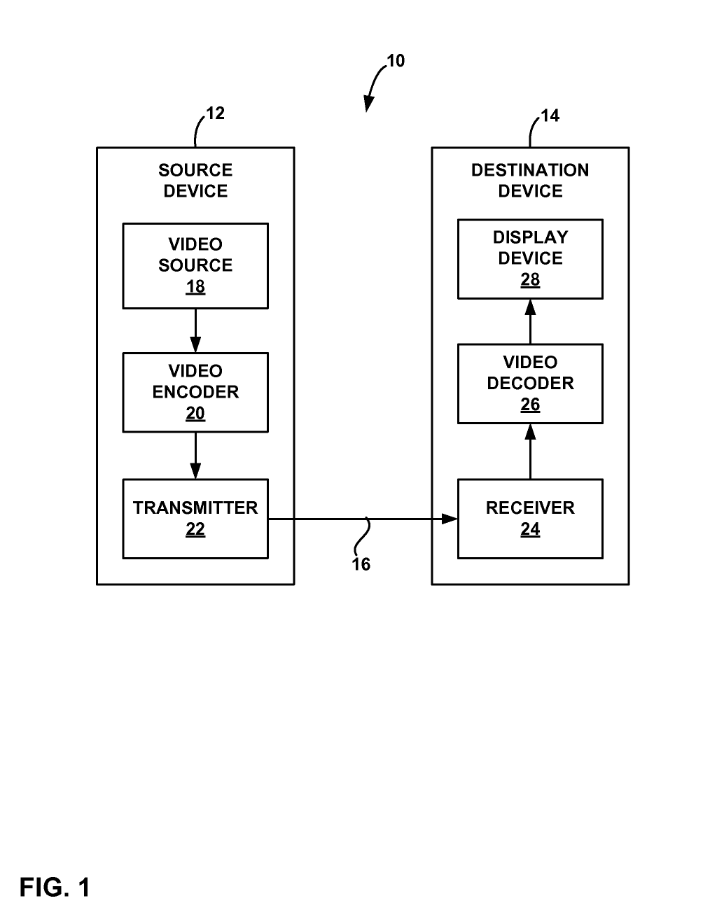

FIG. 1 is a block diagram illustrating a video encoding and decoding system 10 that performs coding techniques as described in this disclosure. As shown in FIG. 1, system 10 includes a source device 12 that transmits encoded video data to a destination device 14 via a communication channel 16. Source device 12 generates coded video data for transmission to destination device 14. Source device 12 may include a video source 18, a video encoder 20, and a transmitter 22. Video source 18 of source device 12 may include a video capture device, such as a video camera, a video archive containing previously captured video, or a video feed from a video content provider. As a further alternative, video source 18 may generate computer graphics-based data as the source video, or a combination of live video and computer-generated video. In some cases, source device 12 may be a so-called camera phone or video phone, in which case video source 18 may be a video camera. In each case, the captured, pre-captured, or computer-generated video may be encoded by video encoder 20 for transmission from source device 12 to destination device 14 via transmitter 22 and communication channel 16.

Video encoder 20 receives video data from video source 18. The video data received from video source 18 may comprise a series of video frames. Video encoder 20 divides the series of frames into series of video blocks and processes the series of video blocks to encode the series of video frames. The series of video blocks may, for example, be entire frames or portions of the frames (i.e., slices). Thus, in some instances, the frames may be divided into slices. Video encoder 20 divides each series of video blocks into blocks of pixels (referred to herein as video blocks or blocks) and operates on the video blocks within individual series of video blocks in order to encode the video data. As such, a series of video blocks (e.g., a frame or slice) may contain multiple video blocks. In general, a video sequence may include multiple frames, a frame may include multiple slices, and a slice may include multiple video blocks. In some cases, the video blocks themselves may be broken into smaller and smaller video blocks, as outlined below.

The video blocks may have fixed or varying sizes, and may differ in size according to a specified coding standard. As an example, the International Telecommunication Union Standardization Sector (ITU-T) H.264/MPEG-4, Part 10, Advanced Video Coding (AVC) (hereinafter “H.264/MPEG-4 Part 10 AVC” standard) supports intra prediction in various block sizes, such as 16×16, 8×8, or 4×4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In H.264, for example, each video block of 16 by 16 pixels, often referred to as a macroblock (MB), may be sub-divided into sub-blocks of smaller sizes and predicted in sub-blocks. In general, MBs and the various sub-blocks may be considered to be video blocks. Thus, MBs may be considered to be video blocks, and if partitioned or sub-partitioned, MBs can themselves be considered to define sets of video blocks.

Efforts are currently in progress to develop a new video coding standard, currently referred to as High Efficiency Video Coding (HEVC), sometimes also referred to as H.265. The standardization efforts are based on a model of a video coding device referred to as the HEVC Test Model (HM). The emerging HEVC standard defines new terms for video blocks. In particular, video blocks (or partitions thereof) may be referred to as “coded units” (or “CUs”). With the HEVC standard, largest coded units (LCUs) may be divided into smaller CUs according to a quadtree partitioning scheme, and the different CUs that are defined in the scheme may be further partitioned into so-called prediction units (PUs). The LCUs, CUs, and PUs are all video blocks within the meaning of this disclosure. Other types of video blocks may also be used, consistent with the HEVC standard or other video coding standards. Thus, the phrase “video blocks” refers to any size of video block. Separate CUs may be included for luma components and scaled sizes for chroma components for a given pixel, although other color spaces could also be used.

Video blocks may have fixed or varying sizes, and may differ in size according to a specified coding standard. Each video frame may include a plurality of slices. Each slice may include a plurality of video blocks, which may be arranged into partitions, also referred to as sub-blocks. In accordance with the quadtree partitioning scheme referenced above and described in more detail below, an N/2×N/2 first CU may comprise a sub-block of an N×N LCU, an N/4×N/4 second CU may also comprise a sub-block of the first CU. An N/8×N/8 PU may comprise a sub-block of the second CU. Similarly, as a further example, block sizes that are less than 16×16 may be referred to as partitions of a 16×16 video block or as sub-blocks of the 16×16 video block. Likewise, for an N×N block, block sizes less than N×N may be referred to as partitions or sub-blocks of the N×N block. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to the residual video block data representing pixel differences between coded video blocks and predictive video blocks. In some cases, a video block may comprise blocks of quantized transform coefficients in the transform domain.

Syntax data within a bitstream may define an LCU for a frame or a slice, which is a largest coding unit in terms of the number of pixels for that frame or slice. In general, an LCU or CU has a similar purpose to a macroblock coded according to H.264, except that LCUs and CUs do not have a specific size distinction. Instead, an LCU size can be defined on a frame-by-frame or slice-by-slice basis, and an LCU be split into CUs. In general, references in this disclosure to a CU may refer to a largest coded unit of a picture or a sub-CU of an LCU. An LCU may be split into sub-CUs, and each sub-CU may be split into sub-CUs. Syntax data for a bitstream may define a maximum number of times an LCU may be split, referred to as CU depth. Accordingly, a bitstream may also define a smallest coding unit (SCU).

As introduced above, an LCU may be associated with a quadtree data structure. In general, a quadtree data structure includes one node per CU, where a root node corresponds to the LCU. If a CU is split into four sub-CUs, the node corresponding to the CU includes four leaf nodes, each of which corresponds to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs.

A CU that is not split may include one or more prediction units (PUs). In general, a PU represents all or a portion of the corresponding CU, and includes data for retrieving a reference sample for the PU. For example, when the PU is intra-mode encoded, the PU may include data describing an intra-prediction mode for the PU. As another example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the PU(s) may also describe, for example, partitioning of the CU into one or more PUs. Partitioning modes may differ between whether the CU is uncoded, intra-prediction mode encoded, or inter-prediction mode encoded.

A CU having one or more PUs may also include one or more transform units (TUs). Following prediction using a PU, a video encoder may calculate a residual value for the portion of the CU corresponding to the PU. The residual value may be transformed, quantized, and scanned. A TU is not necessarily limited to the size of a PU. Thus, TUs may be larger or smaller than corresponding PUs for the same CU. In some examples, the maximum size of a TU may be the size of the corresponding CU. The TUs may comprise the data structures that include the residual transform coefficients associated with a given CU. This disclosure also uses the terms “block” and “video block” to refer to any of an LCU, CU, PU, SCU, or TU.

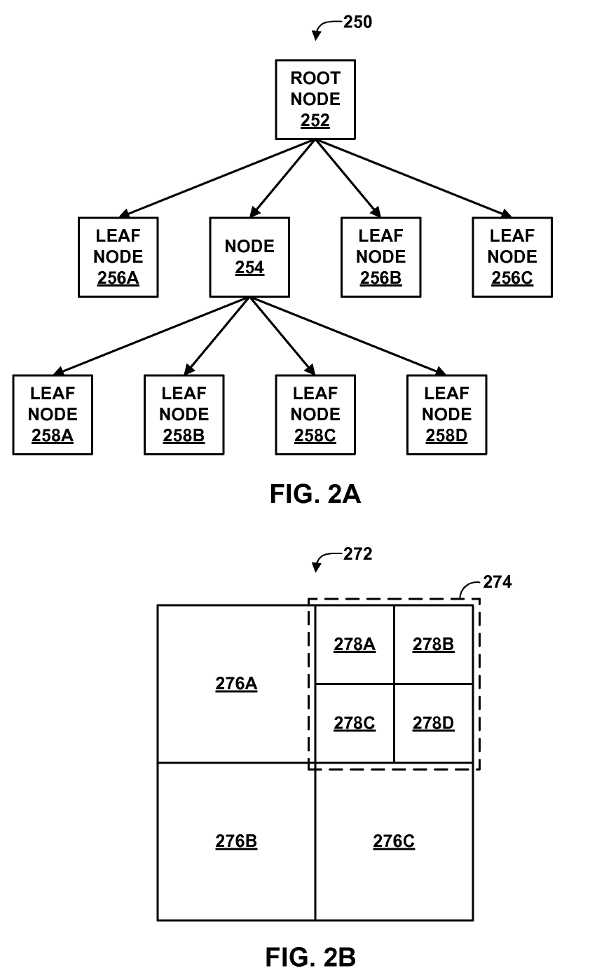

FIGS. 2A and 2B are conceptual diagrams illustrating an example quadtree 250 and a corresponding LCU 272. FIG. 2A depicts an example quadtree 250, which includes nodes arranged in a hierarchical fashion. Each node in a quadtree, such as quadtree 250, may be a leaf node with no children, or have four child nodes. In the example of FIG. 2A, quadtree 250 includes root node 252. Root node 252 has four child nodes, including leaf nodes 256A-256C (leaf nodes 256) and node 254. Because node 254 is not a leaf node, node 254 includes four child nodes, which in this example, are leaf nodes 258A-258D (leaf nodes 258). Each node in quadtree 250 may represent an LCU, a CU and/or an SCU.

Quadtree 250 may include data describing characteristics of a corresponding LCU, such as LCU 272 in this example. For example, quadtree 250, by its structure, may describe splitting of the LCU into sub-CUs. Assume that LCU 272 has a size of 2N×2N. LCU 272, in this example, has four sub-CUs 276A-276C (sub-CUs 276) and 274, each of size N×N. Sub-CU 274 is further split into four sub-CUs 278A-278D (sub-CUs 278), each of size N/2×N/2. The structure of quadtree 250 corresponds to the splitting of LCU 272, in this example. That is, root node 252 corresponds to LCU 272, leaf nodes 256 correspond to sub-CUs 276, node 254 corresponds to sub-CU 274, and leaf nodes 258 correspond to sub-CUs 278. leaf nodes 258 may also be referred to as SCU's because they are the smallest CU's in quadtree 250.

Data for nodes of quadtree 250 may describe whether the CU corresponding to the node is split. If the CU is split, four additional nodes may be present in quadtree 250. In some examples, a node of a quadtree may be implemented similar to the following pseudocode:

quadtree_node {

boolean split_flag(1);
// signaling data
if (split_flag) {

quadtree_node child1;
quadtree_node child2;
quadtree_node child3;
quadtree_node child4;

}

}

The split_flag value may be a one-bit value representative of whether the CU corresponding to the current node is split. If the CU is not split, the split_flag value may be ‘0’, while if the CU is split, the split_flag value may be ‘1’. With respect to the example of quadtree 250, an array of split flag values may be 101000000.

In some examples, each of sub-CUs 276 and sub-CUs 278 may be intra-prediction encoded using the same intra-prediction mode. Accordingly, video encoder 20 may provide an indication of the intra-prediction mode in root node 252. Moreover, certain sizes of sub-CUs may have multiple possible transforms for a particular intra-prediction mode. In accordance with the techniques of this disclosure, video encoder 20 may provide an indication of the transform to use for such sub-CUs in root node 252. For example, sub-CUs of size N/2×N/2 may have multiple possible transforms available. Video encoder 20 may signal the transform to use in root node 252. Accordingly, video decoder 26 may determine the transform to apply to sub-CUs 278 based on the intra-prediction mode signaled in root node 252 and the transform signaled in root node 252.

As such, video encoder 20 need not signal transforms to apply to sub-CUs 276 and sub-CUs 278 in leaf nodes 256 and leaf nodes 258, but may instead simply signal an intra-prediction mode and, in some examples, a transform to apply to certain sizes of sub-CUs, in root node 252, in accordance with the techniques of this disclosure. In this manner, these techniques may reduce the overhead cost of signaling transform functions for each sub-CU of an LCU, such as LCU 272.

In some examples, intra-prediction modes for sub-CUs 276 and/or sub-CUs 278 may be different than intra-prediction modes for LCU 272. Video encoder 120 and video decoder 26 may be configured with functions that map an intra-prediction mode signaled at root node 252 to an available intra-prediction mode for sub-CUs 276 and/or sub-CUs 278. The function may provide a many-to-one mapping of intra-prediction modes available for LCU 272 to intra-prediction modes for sub-CUs 276 and/or sub-CUs 278.

Smaller video blocks can provide better resolution, and may be used for locations of a video frame that include high levels of detail. Larger video blocks can provide greater coding efficiency, and may be used for locations of a video frame that include a low level of detail. Again, a slice may be considered to be a plurality of video blocks and/or sub-blocks. Each slice may be an independently decodable series of video blocks of a video frame. Alternatively, frames themselves may be decodable series of video blocks, or other portions of a frame may be defined as decodable series of video blocks. The term “series of video blocks” may refer to any independently decodable portion of a video frame such as an entire frame, a slice of a frame, a group of pictures (GOP) also referred to as a sequence, or another independently decodable unit defined according to applicable coding techniques. Aspects of this invention might be described in reference to frames or slices, but such references are merely exemplary. It should be understood that generally any series of video blocks may be used instead of a frame or a slice.

For each of the video blocks, video encoder 20 selects a block type for the block. The block type may indicate whether the block is predicted using inter-prediction or intra-prediction as well as a partition size of the block. For example, H.264/MPEG-4 Part 10 AVC standard supports a number of inter- and intra-prediction block types including Inter 16×16, Inter 16×8, Inter 8×16, Inter 8×8, Inter 8×4, Inter 4×8, Inter 4×4, Intra 16×16, Intra 8×8, and Intra 4×4. As described in detail below, video encoder 20 may select one of the block types for each of the video blocks.

Video encoder 20 selects a prediction mode for a video block. In the case of an intra-coded video block, the prediction mode may determine the manner in which to predict the current video block using one or more previously encoded video blocks. In the H.264/MPEG-4 Part 10 AVC standard, for example, video encoder 20 may select one of nine possible unidirectional prediction modes for each Intra 4×4 block, which include a vertical prediction mode, a horizontal prediction mode, a DC prediction mode, a diagonal down/left prediction mode, a diagonal down/right prediction mode, a vertical-right prediction mode, a horizontal-down predication mode, a vertical-left prediction mode and a horizontal-up prediction mode. Similar prediction modes are used to predict each Intra 8×8 block. For an Intra 16×16 block, video encoder 20 may select one of four possible unidirectional modes, which include a vertical prediction mode, a horizontal prediction mode, a DC prediction mode, and a planar prediction mode.

The newly emerging HEVC standard can utilize more than the nine prediction modes of H.264. For example, the newly emerging HEVC standard may utilize 35 intra prediction modes (which include 33 directional modes, a DC mode and a planar mode) for 8×8, 16×16, and 32×32 blocks, and may use either 18 or 35 signaled intra prediction modes for 4×4 blocks. The number of signaled prediction modes may not be the maximum number of prediction modes that can be used for a particular block. A 4×4 block, for example, may only have 18 signaled prediction modes but may be able to inherit modes from a larger block that uses 35 prediction modes. The additional directional modes in HEVC allow for better directional granularity in the intra-prediction. However, the addition of intra prediction modes presents challenges for intra-mode signaling.

After selecting the prediction mode for the video block, video encoder 20 generates a predicted video block using the selected prediction mode. The predicted video block is subtracted from the original video block to form a residual block. The residual block includes a set of pixel difference values that quantify differences between pixel values of the original video block and pixel values of the generated prediction block. The residual block may be represented in a two-dimensional block format (e.g., a two-dimensional matrix or array of pixel difference values).

Following generation of the residual block, video encoder 20 may perform a number of other operations on the residual block before encoding the block. Video encoder 20 may apply a transform, such as an integer transform, a DCT transform, a directional transform, or a wavelet transform to the residual block of pixel values to produce a block of transform coefficients. Thus, video encoder 20 converts the residual pixel values to transform coefficients (also referred to as residual transform coefficients). The residual transform coefficients may be referred to as a transform block or coefficient block. The transform or coefficient block may be a one-dimensional representation of the coefficients when non-separable transforms are applied or a two-dimensional representation of the coefficients when separable transforms are applied. Non-separable transforms may include non-separable directional transforms. Separable transforms may include separable directional transforms, DCT transforms, integer transforms, and wavelet transforms.

Following transformation, video encoder 20 performs quantization to generate quantized transform coefficients (also referred to as quantized coefficients or quantized residual coefficients). Again, the quantized coefficients may be represented in one-dimensional vector format or two-dimensional block format. Quantization generally refers to a process in which coefficients are quantized to possibly reduce the amount of data used to represent the coefficients. The quantization process may reduce the bit depth associated with some or all of the coefficients. As used herein, the term “coefficients” may represent transform coefficients, quantized coefficients or other type of coefficients. The techniques of this disclosure may, in some instances, be applied to residual pixel values as well as transform coefficients and quantized transform coefficients. However, for purposes of illustration, the techniques of this disclosure will be described in the context of quantized transform coefficients.

When separable transforms are used and the coefficient blocks are represented in a two-dimensional block format, video encoder 20 scans the coefficients from the two-dimensional format to a one-dimensional format. In other words, video encoder 20 may scan the coefficients from the two-dimensional block to serialize the coefficients into a one-dimensional vector of coefficients. Video encoder 20 may adjust the scan order used to convert the coefficient block to one dimension based on collected statistics. The statistics may comprise an indication of the likelihood that a given coefficient value in each position of the two-dimensional block is significant (i.e., non-zero) or zero and may, for example, comprise a count, a probability or other statistical metric associated with each of the coefficient positions of the two-dimensional block. In some instances, statistics may only be collected for a subset of the coefficient positions of the block.

When the scan order is evaluated, e.g., after a particular number of blocks, the scan order may be changed such that coefficient positions within the block determined to have a higher probability of having non-zero coefficients are scanned prior to coefficient positions within the block determined to have a lower probability of having non-zero coefficients. In this way, an initial scanning order may be adapted to more efficiently group non-zero coefficients at the beginning of the one-dimensional coefficient vector and zero valued coefficients at the end of the one-dimensional coefficient vector. This may in turn reduce the number of bits spent on entropy coding since there are shorter runs of zeros between non-zeros coefficients at the beginning of the one-dimensional coefficient vector and one longer run of zeros at the end of the one-dimensional coefficient vector. Coding of transform coefficients sometimes involves the coding of a significance map to identify the significant (i.e., non-zero) coefficients, and coding of levels or values for any significant coefficients.

Following the scanning of the coefficients, video encoder 20 encodes each of the video blocks of the series of video blocks using any of a variety of entropy coding methodologies, such as context adaptive variable length coding (CAVLC), context adaptive binary arithmetic coding (CABAC), run length coding or the like. As will be discussed in more detail below, aspects of the present disclosure include coding the prediction mode selected by video encoder 20 as a combination of a main mode and a refinement to the main mode.

Source device 12 transmits the encoded video data to destination device 14 via transmitter 22 and channel 16. Communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting encoded video data from source device 12 to destination device 14.

Destination device 14 may include a receiver 24, video decoder 26, and display device 28. Receiver 24 receives the encoded video bitstream from source device 12 via channel 16. Video decoder 26 applies entropy decoding to decode the encoded video bitstream to obtain header information and quantized residual coefficients of the coded video blocks of the coded unit. Each coding level may have its own associated header and header information. For example, a series of video blocks might have a header, and each video block within the series might also have a header. The signaling techniques described in this disclosure can be included in the header (or other data structure such as a footer) associated with each video block. Thus, each header for each video block might include bits signaling the prediction mode for that video block. In some instances this signaling might include a first group of bits identifying a main mode and a second group of bits identifying a refinement to the main mode. According to techniques of this disclosure, however, whether or not to use the non-main modes for a particular series of video blocks might be an encoder level decision, and this decision might be signaled from video encoder 20 to video decoder 26 in a header for the series of the video blocks. If, in the header of a series video blocks, video encoder 20 signals to video decoder 26 that non-main modes will not be used for the series of video blocks, then bits identifying a refinement do not need to be included in the headers of the video blocks.

As described above, the quantized residual coefficients encoded by source device 12 are encoded as a one-dimensional vector. Video decoder 26 therefore inverse scans the quantized residual coefficients of the coded video blocks to convert the one-dimensional vector of coefficients back into a two-dimensional block of quantized residual coefficients. Like video encoder 20, video decoder 26 may collect statistics that indicate the likelihood that a given coefficient position in the video block is zero or non-zero and thereby adjust the scan order in the same manner that was used in the encoding process. Accordingly, reciprocal adaptive scan orders can be applied by video decoder 26 (relative to those applied by video encoder 20) in order to change the one-dimensional vector representation of the serialized quantized transform coefficients back to two-dimensional blocks of quantized transform coefficients.

Video decoder 26 reconstructs each of the blocks of the series of video blocks using the decoded header information and the decoded residual information. In particular, video decoder 26 may generate a prediction video block for the current video block and combine the prediction block with a corresponding residual video block to reconstruct each of the video blocks. The prediction mode used by video encoder 20 may be encoded in the header information as a combination of a main mode and a refinement to the main mode. Video decoder 26 may use the main mode and refinement in generating the prediction block.

Destination device 14 may display the reconstructed video blocks to a user via display device 28. Display device 28 may comprise any of a variety of display devices such as a cathode ray tube (CRT), a liquid crystal display (LCD), a plasma display, a light emitting diode (LED) display, an organic LED display, or another type of display unit.

In some cases, source device 12 and destination device 14 may operate in a substantially symmetrical manner. For example, source device 12 and destination device 14 may each include video encoding and decoding components. Hence, system 10 may support one-way or two-way video transmission between devices 12, 14, e.g., for video streaming, video broadcasting, or video telephony. A device that includes video encoding and decoding components may also form part of a common encoding, archival and playback device such as a digital video recorder (DVR).

Video encoder 20 and video decoder 26 may operate according to any of a variety of video compression standards, including the newly emerging HEVC standard. Although not shown in FIG. 1, in some aspects, video encoder 20 and video decoder 26 may each be integrated with an audio encoder and decoder, respectively, and may include appropriate MUX-DEMUX units, or other hardware and software, to handle encoding of both audio and video in a common data stream or separate data streams. In this manner, source device 12 and destination device 14 may operate on multimedia data. If applicable, the MUX-DEMUX units may conform to the ITU H.223 multiplexer protocol, or other protocols such as the user datagram protocol (UDP).

Video encoder 20 and video decoder 26 may comprise specific machines designed or specifically programmed for video coding, and each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 26 may be included in one or more encoders or decoders, either of which may be integrated as part of a combined encoder/decoder (CODEC) in a respective mobile device, subscriber device, broadcast device, server, or the like. In addition, source device 12 and destination device 14 each may include appropriate modulation, demodulation, frequency conversion, filtering, and amplifier components for transmission and reception of encoded video, as applicable, including radio frequency (RF) wireless components and antennas sufficient to support wireless communication. For ease of illustration, however, such components are summarized as being transmitter 22 of source device 12 and receiver 24 of destination device 14 in FIG. 1.

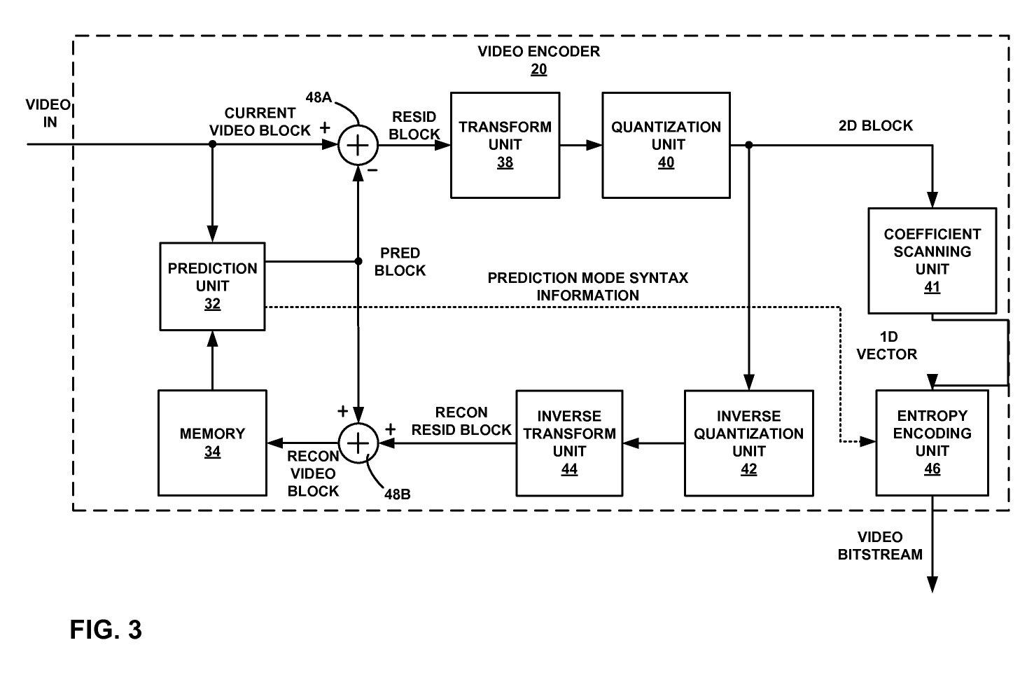

FIG. 3 is a block diagram illustrating example video encoder 20 of FIG. 1 in further detail. Video encoder 20 performs intra- and inter-coding of blocks within a series of video blocks. Intra-coding relies on spatial prediction to reduce or remove spatial redundancy in video data within a given series of video blocks, such as a frame or slice. For intra-coding, video encoder 20 forms a spatial prediction block based on one or more previously encoded blocks within the same series of video blocks as the block being coded. Inter-coding relies on temporal prediction to reduce or remove temporal redundancy within adjacent frames of a video sequence. For inter-coding, video encoder 20 performs motion estimation to track the movement of closely matching video blocks between two or more adjacent frames.

In the example of FIG. 3, video encoder 20 includes a prediction unit 32, memory 34, transform unit 38, quantization unit 40, coefficient scanning unit 41, inverse quantization unit 42, inverse transform unit 44 and prediction unit 32. Video encoder 20 also includes summers 48A and 48B (“summers 48”). An in-loop deblocking filter (not shown) may be applied to reconstructed video blocks to reduce or remove blocking artifacts. Depiction of different features in FIG. 3 as units is intended to highlight different functional aspects of the devices illustrated and does not necessarily imply that such units must be realized by separate hardware or software components. Rather, functionality associated with one or more units may be integrated within common or separate hardware or software components.

Prediction unit 32 receives video information (labeled “VIDEO IN” in FIG. 3), e.g., in the form of a sequence of video frames, from video source 18 (FIG. 1). Prediction unit 32 divides each of the video frames into series of video blocks that include a plurality of video blocks. As described above, the series of video blocks may be an entire frame or a portion of a frame (e.g., slice of the frame). In one instance, prediction unit 32 may initially divide each of the series of video blocks into a plurality of video blocks with a partition size of 16×16 (i.e., into macroblocks). Prediction unit 32 may further sub-divide each of the 16×16 video blocks into smaller blocks such as 8×8 video blocks or 4×4 video blocks.

Video encoder 20 performs intra- or inter-coding for each of the video blocks of the series of video blocks on a block by block basis based on the block type of the block. Prediction unit 32 assigns a block type to each of the video blocks that may indicate the selected partition size of the block as well as whether the block is to be predicted using inter-prediction or intra-prediction. In the case of inter-prediction, prediction unit 32 also decides the motion vectors. In the case of intra-prediction, prediction unit 32 also decides the prediction mode to use to generate a prediction block. As will be discussed in more detail below, prediction unit 32 can choose the prediction mode from a set of prediction modes. In one example, the set of prediction modes might have 34 different prediction modes, where each prediction mode corresponds to a different angle of the prediction direction. Within the set of prediction modes, there can be a set of main modes, where the set of main modes is a subset of the set of prediction modes. In one example, the set of main modes might include nine prediction modes.

Prediction unit 32 then generates a prediction block. The prediction block may be a predicted version of the current video block. The current video block refers to a video block currently being coded. In the case of inter-prediction, e.g., when a block is assigned an inter-block type, prediction unit 32 may perform temporal prediction for inter-coding of the current video block. Prediction unit 32 may, for example, compare the current video block to blocks in one or more adjacent video frames to identify a block in the adjacent frame that most closely matches the current video block, e.g., a block in the adjacent frame that has a smallest MSE, SSD, SAD, or other difference metric. Prediction unit 32 selects the identified block in the adjacent frame as the prediction block.

In the case of intra-prediction, i.e., when a block is assigned an intra-block type, prediction unit 32 may generate the prediction block based on one or more previously encoded neighboring blocks within a common series of video blocks (e.g., frame or slice). Prediction unit 32 may, for example, perform spatial prediction to generate the prediction block by performing interpolation using one or more previously encoded neighboring blocks within the current frame. The one or more adjacent blocks within the current frame may, for example, be retrieved from memory 34, which may comprise any type of memory or data storage device to store one or more previously encoded frames or blocks.

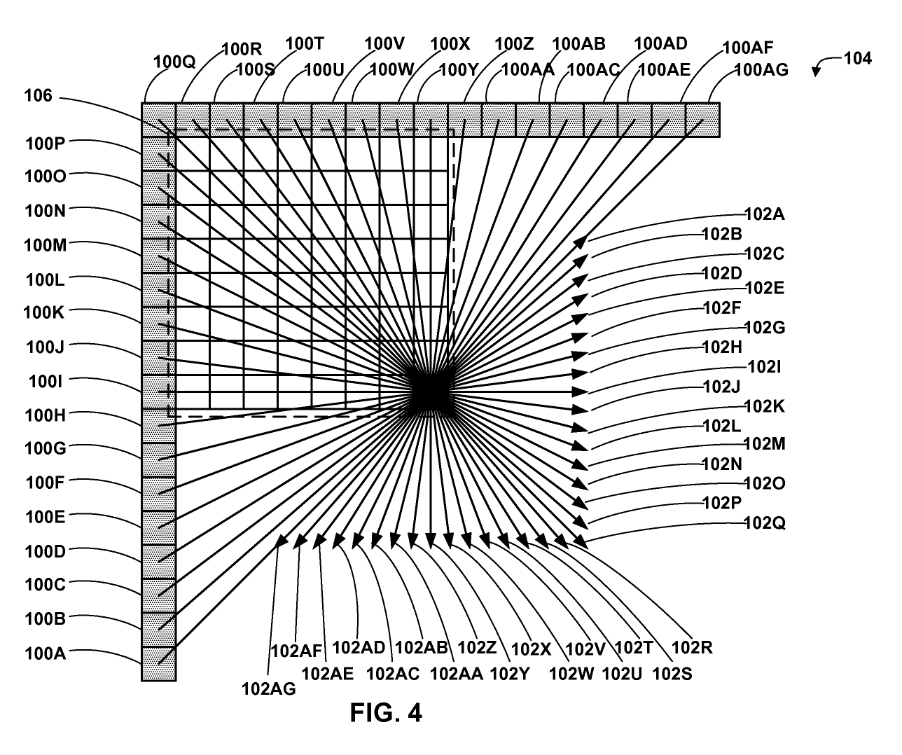

Prediction unit 32 may perform the interpolation in accordance with one of a set of prediction modes. FIG. 4 is a conceptual diagram illustrating graph 104 depicting an example set of directions associated with intra-prediction modes, such as the modes of the HEVC test model. In the example of FIG. 4, block 106 can be predicted from neighboring pixels 100A-100AG (neighboring pixels 100) depending on a selected intra-prediction mode. Arrows 102A-102AG (arrows 102) represent directions or angles associated with various intra-prediction modes. In other examples, more or fewer intra-prediction modes may be provided. Although the example of block 106 is an 8×8 pixel block, in general, a block may have any number of pixels, e.g., 4×4, 8×8, 16×16, 32×32, 64×64, 128×128, etc. Although the HEVC test model provides for square PUs, the techniques of this disclosure may also be applied to other block sizes, e.g., N×M blocks, where N is not necessarily equal to M. In some cases, filtering may also be applied on pixels used for directional intra-prediction.

An intra-prediction mode may be defined according to an angle of the prediction direction relative to, for example, a horizontal axis that is perpendicular to the vertical sides of block 106. Thus, each of arrows 102 may represent a particular angle of a prediction direction of a corresponding intra-prediction mode. In some examples, an intra-prediction direction mode may be defined by an integer pair (dx, dy), which may represent the direction the corresponding intra-prediction mode uses for context pixel extrapolation. That is, the angle of the intra-prediction mode may be calculated as dy/dx. In other words, the angle may be represented according to the horizontal offset dx and the vertical offset dy. The value of a pixel at location (x, y) in block 106 may be determined from the one of neighboring pixels 100 through which a line passes that also passes through location (x, y) with an angle of dy/dx.

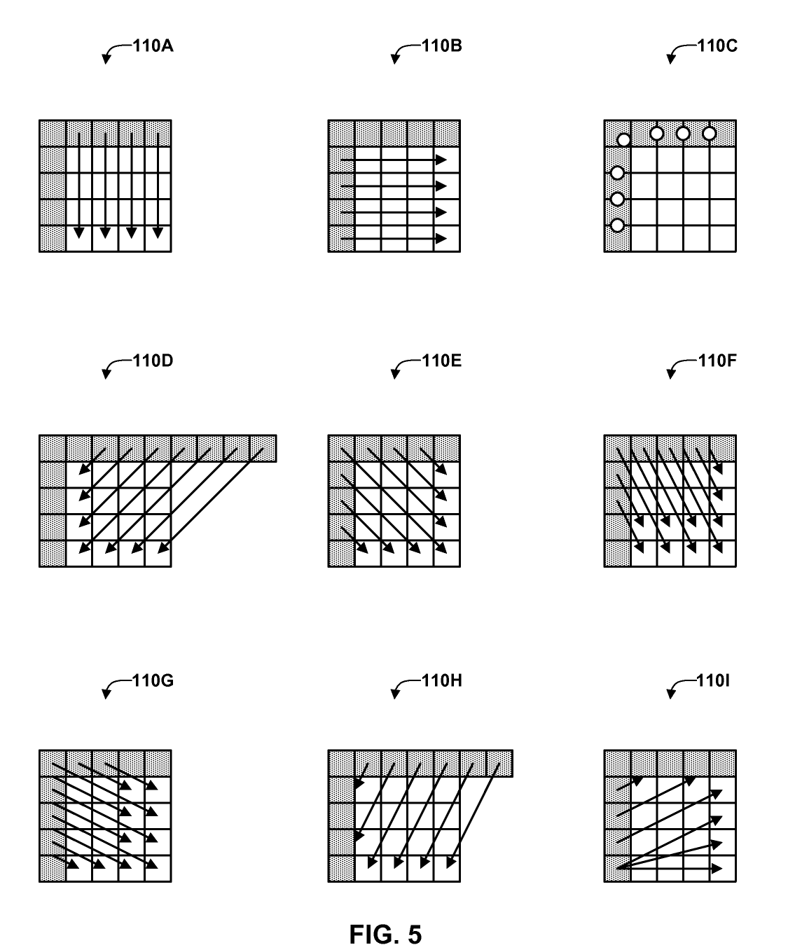

FIG. 5 is a conceptual diagram illustrating intra-prediction modes 110A-110I (intra-prediction modes 110) of H.264. Intra-prediction mode 110C corresponds to a DC intra-prediction mode, and is therefore not necessarily associated with an actual angle. The remaining intra-prediction modes 110 may be associated with an angle, similar to angles of arrows 102 of FIG. 4. For example, the angle of intra-prediction mode 110A corresponds to arrow 102Y, the angle of intra-prediction mode 110B corresponds to arrow 102I, the angle of intra-prediction mode 110D corresponds to arrow 102AG, the angle of intra-prediction mode 110E corresponds to arrow 102Q, the angle of intra-prediction mode 110F corresponds to arrow 102U, the angle of intra-prediction mode 110G corresponds to arrow 102M, the angle of intra-prediction mode 110H corresponds to arrow 102AC, and the angle of intra-prediction mode 110I corresponds to arrow 102E. Throughout this disclosure, intra prediction modes 110 of FIG. 5 and their corresponding modes in FIG. 4 may be referred to as main modes.

According to techniques of this disclosure, the remaining modes of FIG. 4 (i.e. the non-main modes, which correspond to arrows 102A, 102B, 102C, 102D, 102F, 102G, 102H, 102J, 102K, 102L, 102N, 102O, 102P, 102R, 102S, 102T, 102V, 102W, 102X, 102Z, 102AA, 102AB, 102AD, 102AE, 102AF can be considered to be a combination of a main mode and a refinement to the main mode. The refinement can correspond to an offset of a main mode. Mode 102L, for example, might be considered to be main mode 102M plus an upward refinement of one refinement unit. Mode 102K might be considered to be main mode 102M plus an upward refinement of two refinement units, and mode 102N might be considered to be main mode 102M plus a refinement of down one. Generally, when signaling a non-main mode as a combination of a main mode and a refinement, the main mode used to signal the non-main mode will be close to the non-main mode, meaning the angle of prediction for the non-main mode will be similar to the angle of prediction for the main mode.

The set of prediction modes described above is described for purposes of illustration. The set of prediction modes may include more or fewer prediction modes, and similarly, the set of main modes described above may include more or fewer prediction modes. Furthermore, additional modes may be defined and filtering could also be applied to pixels identified by various prediction modes, consistent with this disclosure. Additionally, the particular main modes selected above are merely intended to be one example and may be different in some implementations. In some implementations, non-directional modes may also be coded as a main mode and a refinement to the main mode. For example, a DC mode may be a main mode, while a planar mode is signaled as a refinement to the DC mode. Furthermore, the ratio of modes to main modes may also be different in different examples of this disclosure. As one example, a set of 17 prediction modes with 9 main modes may also be used. The 9 main modes may generally correspond to the modes supported in the ITU H.264 standard.

To determine which one of the plurality of prediction modes to select for a particular block, prediction unit 32 may estimate a coding cost metric, e.g., Lagrangian cost metric, for each of the prediction modes of the set, and select the prediction mode with the smallest coding cost metric. The coding cost metric may balance the encoding rate (the number of bits) with the encoding quality or level of distortion in the encoded video, and may be referred to as a rate-distortion metric. In some instances, prediction unit 32 may estimate the coding cost for only a portion of the set of possible prediction modes. For example, prediction unit 32 may select the portion of the prediction modes of the set based on the prediction mode selected for one or more neighboring video blocks. Prediction unit 32 generates a prediction block using the selected prediction mode. In some implementations, prediction unit 32 might be biased towards the main modes, meaning, for example, if the Lagrangian cost metric for a main mode is roughly equal to or only slightly worse than the Lagrangian cost metric for a non-main mode, prediction unit 32 may be configured to select the main mode as the prediction mode for a particular cost as opposed to the non-main mode. In instances where a non-main mode can significantly improve the quality of a reconstructed image, however, prediction unit 32 can still select the non-main mode. As will be described in more detail below, biasing prediction unit 32 towards the main modes can result in reduced bit overhead when signaling the prediction mode to a video decoder.

After generating the prediction block, video encoder 20 generates a residual block by subtracting the prediction block produced by prediction unit 32 from the current video block at summer 48A. The residual block includes a set of pixel difference values that quantify differences between pixel values of the current video block and pixel values of the prediction block. The residual block may be represented in a two-dimensional block format (e.g., a two-dimensional matrix or array of pixel values). In other words, the residual block is a two-dimensional representation of the pixel values.

Transform unit 38 applies a transform to the residual block to produce residual transform coefficients. Transform unit 38 may, for example, apply a DCT, an integer transform, directional transform, wavelet transform, or a combination thereof. Transform unit 38 may selectively apply transforms to the residual block based on the prediction mode selected by prediction unit 32 to generate the prediction block. In other words, the transform applied to the residual information may be dependent on the prediction mode selected for the block by prediction unit 32.

Transform unit 38 may maintain a plurality of different transforms and selectively apply the transforms to the residual block based on the prediction mode of the block. The plurality of different transforms may include DCTs, DCT-like transforms, integer transforms, directional transforms, wavelet transforms, matrix multiplications, or combinations thereof. In some instances, transform unit 38 may maintain a DCT or integer transform and a plurality of directional transforms, and selectively apply the transforms based on the prediction mode selected for the current video block. Transform unit 38 may, for example, apply the DCT or integer transform to residual blocks with prediction modes that exhibit limited directionality and apply one of the directional transforms to residual blocks with prediction modes that exhibit significant directionality. In other instances, transform unit 38 may maintain a different directional transform for each of the possible prediction modes, and apply the corresponding directional transforms based on the selected prediction mode of the block.

After applying the transform to the residual block of pixel values, quantization unit 40 quantizes the transform coefficients to further reduce the bit rate. Following quantization, inverse quantization unit 42 and inverse transform unit 44 may apply inverse quantization and inverse transformation, respectively, to reconstruct the residual block (labeled “RECON RESID BLOCK” in FIG. 3). Summer 48B adds the reconstructed residual block to the prediction block produced by prediction unit 32 to produce a reconstructed video block for storage in memory 34. The reconstructed video block may be used by prediction unit 32 to intra- or inter-code a subsequent video block.

As described above, when separable transforms are used, which may include DCT or separable directional transforms, the resulting transform coefficients are represented as two-dimensional coefficient matrices. Therefore, following quantization, coefficient scanning unit 41 scans the coefficients from the two-dimensional block format to a one-dimensional vector format, a process often referred to as coefficient scanning.

Entropy encoding unit 46 receives the one-dimensional coefficient vector that represents the residual coefficients of the block as well as block syntax information, including prediction mode syntax information, for the block in the form of one or more syntax elements. The syntax elements may identify particular characteristics of the current video block, including the prediction mode. These syntax elements may be received from other components, for example, from prediction unit 32, within video encoder 20. Entropy encoding unit 46 encodes the syntax information and the residual information for the current video block to generate an encoded bitstream (labeled “VIDEO BITSTREAM” in FIG. 3).

Prediction unit 32 generates one or more of the syntax elements of each of the blocks in accordance with the techniques described in this disclosure. In particular, prediction unit 32 may generate the syntax elements of the current block based on the syntax elements of one or more previously encoded video blocks. As such, prediction unit 32 may include one or more buffers to store the syntax elements of the one or more previously encoded video blocks. Prediction unit 32 may analyze any number of neighboring blocks at any location to assist in generating the syntax elements of the current video block. For purposes of illustration, prediction unit 32 will be described as generating the prediction mode based on a previously encoded block located directly above the current block (i.e., upper neighboring block) and a previously encoded block located directly to the left of the current block (i.e., left neighboring block). The information or modes associated with other neighboring blocks could also be used.

Operation of prediction unit 32 will be described with reference to the set of 35 prediction modes described above. Based on the prediction mode of the upper neighboring block and the prediction mode of the left neighboring block, prediction unit 32 selects a most probable mode from the group of main modes. The selection of a most probable mode can be based on a mapping of combinations of upper and left prediction modes to most probable modes, selected from the group of main modes. Accordingly, each combination of upper neighbor prediction mode and left neighbor prediction mode can have a corresponding main mode that is a most probable mode for a current block. Thus, if the upper neighboring prediction mode can be any of 35 possible prediction modes and the left neighboring prediction mode can be can be any of 35 possible prediction modes, then there are 35² (i.e. 1225) combinations for upper and left prediction modes. Each of the 1225 combinations can be mapped to one of the nine main modes. The mapping of upper neighbor prediction modes and left neighbor prediction modes to main modes can be dynamically updated by prediction unit 32 based on statistics accumulated during coding, or alternatively, may be set based on a fixed criteria, such as which main mode is closest to the upper and left prediction modes.

Referring back to FIG. 4, for example, if the upper neighboring block of a current block and the left neighboring block of a current block were both coded using prediction mode 102M, which is a main mode, then the most probable mode of the current block might also be prediction mode 102M. If, however, the upper neighboring block and the left neighboring block were both coded using prediction mode 102Z, then the most probable mode might not be mode 102Z because mode 102Z is not a main mode, but instead, the most probable mode for the current block might be 102Y, which is a main mode. In some instances, the prediction modes for the upper neighboring block and left neighboring block may be different, but the combination of the upper and left prediction modes still maps to a single main mode that serves as a most probable mode for a current block.

If the prediction mode of the current block is equal to the main mode that is selected as the most probable mode, then prediction unit 32 can code a “1” to represent the prediction mode of the current block. In such instances, prediction unit 32 does not need to generate any more bits for the prediction mode. However, if the prediction mode of the current block is not equal to the most probable mode, then prediction unit 32 generates a first bit of “0,” followed by additional bits signaling the prediction mode of the current block. The prediction mode of the current block can be signaled as a combination of a main mode and a refinement.

In some instances, when the upper neighboring block of a current block and the left neighboring block of a current block are both coded using the same prediction mode but this same prediction mode is not a main mode, then prediction unit 32 may treat this same prediction mode in a manner similar to most probable modes. Prediction unit 32 may, for example, generate a first syntax element indicating if the prediction of the mode of the current block is the same as the prediction mode of both the upper neighbor and the left neighbor. If the prediction mode of the current block is not the same as the prediction mode of both the upper neighbor and the left neighbor, then prediction unit 32 may generate additional syntax elements identifying the actual mode as a combination of a main mode and a refinement to the main mode.

When signaling a combination of main mode and a refinement, prediction unit 32 can apply principles of variable length coding (VLC) when coding the main mode. For example, prediction unit 32 can maintain a VLC table that matches the most frequently occurring main modes to the shortest codewords. The VLC table might maintain a fixed mapping of main modes to codewords, or in some implementations, might be dynamically updated based on statistics accumulated during the coding process. In such a table, it might be common for the main modes corresponding to horizontal prediction (i.e. mode 102J on FIG. 4) and vertical prediction (i.e. mode 102Y on FIG. 4) to be the most frequently occurring, and thus, mapped to the shortest codewords.

Prediction unit 32 may also select codewords for main modes based on context-adaptive VLC (CAVLC). When utilizing CAVLC, prediction unit 32 can maintain a plurality of different VLC tables for a plurality of different contexts. The prediction modes of neighboring blocks and their corresponding most probable mode, for example, might define a context. If mode 102E is identified as a most probable mode, then prediction unit 32 might select a codeword for a main mode based off of a first VLC table, but if mode 102I is identified as a most probable mode, then prediction unit 32 might select a codeword from a second VLC table that is different than the first VLC table.

Prediction unit 32 can encode the refinement to the main mode using a fixed number bits or may encode the refinement using VLC or CAVLC. If each mode, for example, has a possibility of 4 refinements, then the refinement can be encoded using two bits.

The operation of prediction unit 32 will now be described using examples based on the modes of FIG. 4 (in which modes 102E, 102I, 102M, 102Q, 102U, 102Y, 102AC, and 102AG are selected as main modes). For purposes of this example, assume that the prediction mode for an upper neighboring block is mode 102H and the prediction mode for a left neighboring block is 102G and assume that the 102H/102G combination of modes maps to a most probable mode of main mode 102I. If the actual prediction mode for the current block is main mode 102I, then prediction unit 32 encodes a first bit of “1” without encoding additional bits describing the prediction mode of the current block. If, however, the prediction mode of the current block is mode 102H instead of mode 102I, then prediction unit 32 encodes a first bit of “0” followed by additional bits identifying a main mode and a refinement to the main mode.

In the case of mode 102H, the main mode might be 102I with a refinement of plus one. Prediction unit 32 might encode main mode 102I using CAVLC, where the most probable mode defines a context. For the context where a most probable mode is 102I, it might be expected that the most frequently occurring main mode for this context will be main mode 102I. Accordingly, the VLC table maintained for the context where mode 102I is the most probable mode might map main mode 102I to the shortest code word, which might even be a single bit. Therefore, using the example introduced above, for prediction unit 32 to signal an actual prediction mode of 102H, prediction unit 32 might signal a first bit to indicate that the actual prediction mode is not the most probable mode, signal a second bit to indicate that the main mode component of the actual prediction mode is mode 102I, and signal two additional bits to signal that the refinement to the main mode is plus one. As the main mode component is signaled using VLC, it will not always be signaled by a single bit. In some instances, it might require multiple bits to the signal main mode. It is also possible, based on implementation preferences, that the main mode component will never be signaled using a single bit. Additionally, signaling of the refinement may also require more or fewer bits depending on the number of possible refinements as well as depending on whether or not VLC is utilized.

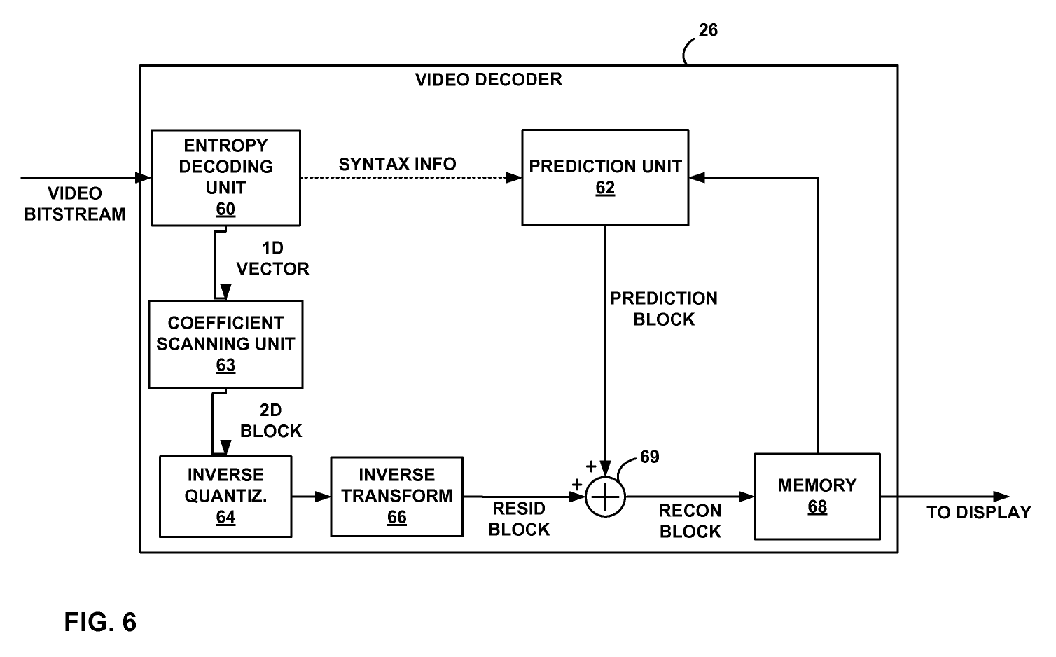

FIG. 6 is a block diagram illustrating an example of video decoder 26 of FIG. 1 in further detail. Video decoder 26 may perform intra- and inter-decoding of blocks within coded units, such as video frames or slices. In the example of FIG. 6, video decoder 26 includes an entropy decoding unit 60, prediction unit 62, coefficient scanning unit 63, inverse quantization unit 64, inverse transform unit 66, and memory 68. Video decoder 26 also includes summer 69, which combines the outputs of inverse transform unit 66 and prediction unit 62.

Entropy decoding unit 60 receives the encoded video bitstream (labeled “VIDEO BITSTREAM” in FIG. 6) and decodes the encoded bitstream to obtain residual information (e.g., in the form of a one-dimensional vector of quantized residual coefficients) and header information (e.g., in the form of one or more header syntax elements). Entropy decoding unit 60 performs the reciprocal decoding function of the encoding performed by encoding unit 46 of FIG. 3. Similarly, prediction unit 62 performs the reciprocal decoding function of the encoding performed by prediction unit 32 of FIG. 3. Description of prediction unit 62 performing decoding of a prediction mode syntax element is described for purposes of example.

In particular, prediction unit 62 analyzes the first bit representing the prediction mode to determine whether the prediction mode of the current block is equal to the most probable mode selected based on previously decoded blocks analyzed, e.g., an upper neighboring block and/or a left neighboring block. In the same manner as prediction unit 32, prediction unit 62 can identify a most probable mode for a current block based on a mapping of combinations of upper and left prediction modes to most probable modes, selected from the group of main modes. Prediction unit 62 can be configured to maintain the same mapping of left and upper neighboring prediction modes to most probable modes as prediction unit 32. Thus, the same most probable mode for a current block can be determined at both video encoder 20 and video decoder 26 without bits identifying the most probable mode needing to be transferred from video encoder 20 to video decoder 26.

Entropy decoding unit 60 may determine that the prediction mode of the current block is equal to the most probable mode when the first bit is “1” and that the prediction mode of the current block is not equal to the most probable mode when the first bit is “0.” If the first bit is “1,” indicating the prediction mode of the current block is equal to the most probable mode, then prediction unit 62 does not need to receive any additional bits. Prediction unit 62 selects the most probable mode as the prediction mode of the current block.

When the first bit is “0,” however, prediction unit 62 determines that the prediction mode of the current block is not the most probable mode. When the prediction mode of the current block is not the most probable mode, prediction unit 62 needs to receive a first group of additional bits to identify a main mode and a second group of additional bits to identify a refinement. Based on the main mode and the refinement, a prediction mode for a current block can be determined. As discussed above, the first group of additional bits identifying the main mode may be coded according to VLC techniques, and thus, the first group of additional bits may have a varying number of total bits and in some instances may be a single bit. The refinement to the main mode may be a fixed number of bits, but as with main mode, may also be coded using VLC techniques, in which case the refinement might also have a varying number of bits.

Prediction unit 62 generates a prediction block using at least a portion of the header information, including the header information identifying the prediction mode. For example, in the case of an intra-coded block, entropy decoding unit 60 may provide at least a portion of the header information (such as the block type and the prediction mode for this block) to prediction unit 62 for generation of a prediction block. Prediction unit 62 generates a prediction block using one or more adjacent blocks (or portions of the adjacent blocks) within a common series of video blocks in accordance with the block type and prediction mode. As an example, prediction unit 62 may, for example, generate a prediction block of the partition size indicated by the block type syntax element using the prediction mode specified by the prediction mode syntax element. The one or more adjacent blocks (or portions of the adjacent blocks) within the current series of video blocks may, for example, be retrieved from memory 68.

Entropy decoding unit 60 also decodes the encoded video data to obtain the residual information in the form of a one-dimensional coefficient vector. If separable transforms are used, coefficient scanning unit 63 scans the one-dimensional coefficient vector to generate a two-dimensional block. Coefficient scanning unit 63 performs the reciprocal scanning function of the scanning performed by coefficient scanning unit 41 of FIG. 3. In particular, coefficient scanning unit 63 scans the coefficients in accordance with an initial scan order to place the coefficients of the one-dimensional vector into a two-dimensional format. In other words, coefficient scanning unit 63 scans the one-dimensional vector to generate the two-dimensional block of quantized coefficients.

After generating the two-dimensional block of quantized residual coefficients, inverse quantization unit 64 inverse quantizes, i.e., de-quantizes, the quantized residual coefficients. Inverse transform unit 66 applies an inverse transform, e.g., an inverse DCT, inverse integer transform, or inverse directional transform, to the de-quantized residual coefficients to produce a residual block of pixel values. Summer 69 sums the prediction block generated by prediction unit 62 with the residual block from inverse transform unit 66 to form a reconstructed video block. In this manner, video decoder 26 reconstructs the frames of video sequence block by block using the header information and the residual information.

Block-based video coding can sometimes result in visually perceivable blockiness at block boundaries of a coded video frame. In such cases, deblock filtering may smooth the block boundaries to reduce or eliminate the visually perceivable blockiness. As such, a deblocking filter (not shown) may also be applied to filter the decoded blocks in order to reduce or remove blockiness. Following any optional deblock filtering, the reconstructed blocks are then placed in memory 68, which provides reference blocks for spatial and temporal prediction of subsequent video blocks and also produces decoded video to drive display device (such as display device 28 of FIG. 1).

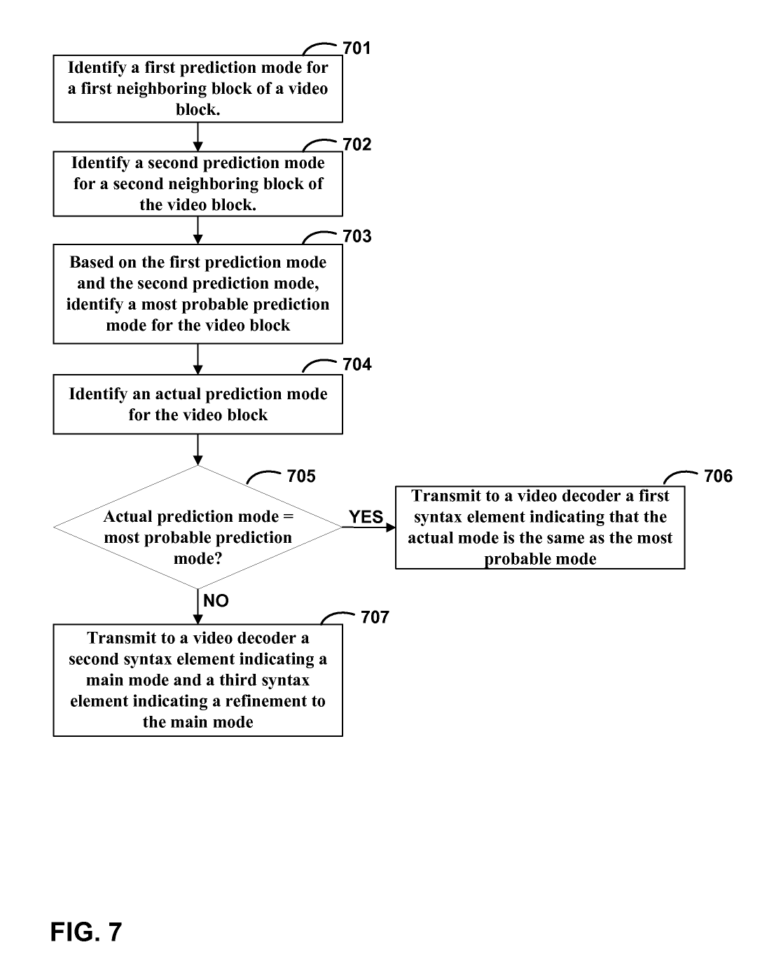

FIG. 7 is a flowchart showing a video encoding method implementing techniques described in this disclosure. The techniques may, for example, be performed by the devices shown in FIGS. 1, 3, and 6 and will be described in relation to the devices shown in FIGS. 1, 3, and 6. Prediction unit 32 identifies a first prediction mode for a first neighboring block of a video block (701). The first neighboring block may, for example, be one of an upper neighbor or a left neighbor for the video block being coded. The first prediction mode is a mode from a set of prediction modes. This disclosure has generally described the set of prediction modes as including 35 prediction modes, although the techniques of this disclosure can also be used with coding schemes that include more or fewer than 35 prediction modes. Prediction unit 32 also identifies a second prediction mode for a second neighboring block of the video block (702). The second neighboring block can be whichever of the upper neighbor block or left neighbor block that was not used as the first neighboring block. The second prediction mode can also be a mode from the set of prediction modes. Based on the first prediction mode and the second prediction mode, prediction unit 32 can identify a most probable prediction mode for the video block (703). The most probable prediction mode can be a mode from a set of main modes, and the set of main modes can be a sub-set of the set of prediction modes. This disclosure has generally described the set of main modes as including 9 prediction modes and the 9 prediction modes as being a subset of the 35 prediction modes, although the techniques of this disclosure can also be used with coding schemes that include more or fewer than 35 prediction modes and more or fewer than 9 main modes.

For the video block, prediction unit 32 can identify an actual prediction mode for the video block (704), and transmit an indication of the actual prediction mode to prediction unit 32. In response to the actual prediction mode being the same as the most probable prediction mode (705, yes), prediction unit 32 can transmit to a video decoder a first syntax element indicating that the actual mode is the same as the most probable mode (706). The first syntax element may, for example, be a single bit. In response to the actual mode not being the same as the most probable prediction mode (705, no), prediction unit 32 can transmit to a video decoder a second syntax element indicating a main mode and a third syntax element indicating a refinement to the main mode (707). The main mode and the refinement to the main mode correspond to the actual prediction mode.

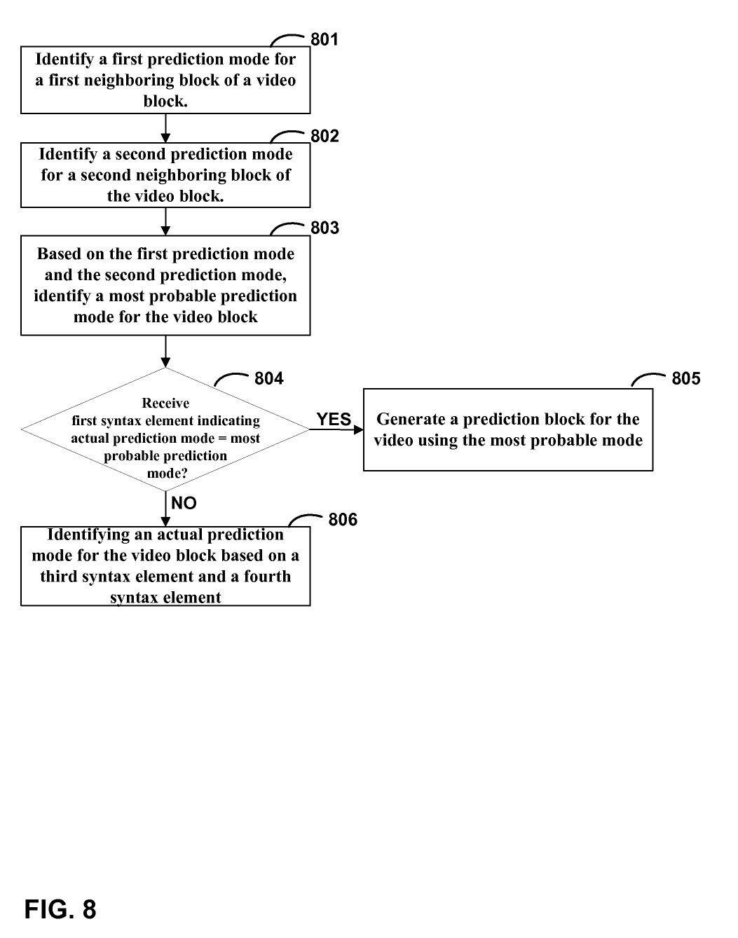

FIG. 8 is a flowchart showing a video decoding method implementing techniques described in this disclosure. The techniques may, for example, be performed by the devices shown in FIGS. 1, 3, and 6 and will be described in relation to the devices shown in FIGS. 1, 3, and 6. Prediction unit 62 can identify a first prediction mode for a first neighboring block of a video block (801). The first neighboring block may, for example, be one of an upper neighbor or a left neighbor for the video block being coded. The first prediction mode is a mode from a set of prediction modes, such as the 35 prediction used as an example throughout this disclosure. Prediction unit 62 can identify a second prediction mode for a second neighboring block of the video block (802). The second neighboring block can be whichever of upper neighbor block or left neighbor block that was not used as the first neighboring block. The second prediction mode can also be a mode from the set of prediction modes. Based on the first prediction mode and the second prediction mode, prediction unit 62 can identify a most probable prediction mode for the video block (803). The most probable prediction mode can be one of a set of main modes, such as the 9 main modes used as an example throughout this disclosure, and the set of main modes can be a sub-set of the set of prediction modes.

In response to prediction unit 62 receiving a first syntax element indicating the actual prediction mode for the video block is the same as the most probable prediction mode (804, yes), prediction unit 62 can generate a prediction block for the video using the most probable prediction mode (805). The first syntax element may, for example, be a single bit indicating the most probable prediction mode is the actual prediction mode for the current block. In response to receiving a second syntax element instead of receiving the first syntax element (804, no), identifying an actual prediction mode for the video block based on a third syntax element and a fourth syntax element (806). The second syntax element may, for example, be a single bit that is the opposite of the first syntax element. Thus, if the first syntax element is a “1,” then the second syntax element can be a “0,” or vice versa. The third syntax element can identify a main mode, and the fourth syntax element can identify a refinement to the main mode.

Although this disclosure has generally assumed that the main modes correspond to the nine modes defined in the H.264 standard, modes other than these nine can be designated as main modes. Additionally, although this disclosure has generally described the use of 35 modes with 9 main modes, the techniques described can be utilized in systems that utilize more or fewer total modes, and/or more or fewer main modes.

In one or more examples, the techniques described in this disclosure may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method of decoding a video block, the method comprising:
identifying a first prediction mode for a first neighboring block of the video block, wherein the first prediction mode is one of a set of prediction modes;
identifying a second prediction mode for a second neighboring block of the video block, wherein the second prediction mode is one of the set of prediction modes;
based on the first prediction mode and the second prediction mode, identifying a most probable prediction mode for the video block, wherein the most probable prediction mode is one of a set of main modes and the set of main modes is a sub-set of the set of prediction modes;
in response to receiving a first syntax element, generating a prediction block for the video using the most probable mode;
in response to receiving a second syntax element, identifying an actual prediction mode for the video block based on a third syntax element and a fourth syntax element, wherein the third syntax element identifies a main mode and the fourth syntax element identifies a refinement to the main mode.

2. The method of claim 1, wherein the first neighboring block is an upper neighboring block.

3. The method of claim 1, wherein the second neighboring block is a left neighboring block.

4. The method of claim 1, wherein the first syntax element is a single bit.

5. The method of claim 1, wherein the second syntax element is coded using variable length coding.

6. The method of claim 1, further comprising:
receiving a fourth syntax element indicating that refinements to main modes will not be signaled for video blocks of a series of video blocks.

7. A video decoder comprising:
a prediction unit to:
identify a first prediction mode for a first neighboring block of the video block, wherein the first prediction mode is one of a set of prediction modes;
identify a second prediction mode for a second neighboring block of the video block, wherein the second prediction mode is one of the set of prediction modes;
based on the first prediction mode and the second prediction mode, identify a most probable prediction mode for the video block, wherein the most probable prediction mode is one of a set of main modes and the set of main modes is a sub-set of the set of prediction modes;
in response to receiving a first syntax element, identify the most probable mode as the actual prediction mode;
in response to receiving a second syntax element, identify an actual prediction mode for the video block based on a third syntax element and a fourth syntax element, wherein the third syntax element identifies a main mode and the fourth syntax element identifies a refinement to the main mode;
generate a prediction block for the video block using the actual prediction mode.

8. The video decoder of claim 7, wherein the first neighboring block is an upper neighboring block.

9. The video decoder of claim 7, wherein the second neighboring block is a left neighboring block.

10. The video decoder of claim 7, wherein the first syntax element is a single bit.

11. The video decoder of claim 7, wherein the second syntax element is coded using variable length coding.

12. The video decoder of claim 7, wherein the prediction unit is further configured to receive a fourth syntax element indicating that refinements to main modes will not be signaled for video blocks of a series of video blocks.

13. An apparatus for decoding video data, the apparatus comprising:
means for identifying a first prediction mode for a first neighboring block of the video block, wherein the first prediction mode is one of a set of prediction modes;
means for identifying a second prediction mode for a second neighboring block of the video block, wherein the second prediction mode is one of the set of prediction modes;
means for identifying a most probable prediction mode for the video block based on the first prediction mode and the second prediction mode, wherein the most probable prediction mode is one of a set of main modes and the set of main modes is a sub-set of the set of prediction modes;
means for generating a prediction block for the video using the most probable mode in response to receiving a first syntax element;
means for identifying, in response to receiving a second syntax element, an actual prediction mode for the video block based on a third syntax element and a fourth syntax element, wherein the third syntax element identifies a main mode and the fourth syntax element identifies a refinement to the main mode.

14. The apparatus of claim 13, wherein the first neighboring block is an upper neighboring block.

15. The apparatus of claim 13, wherein the second neighboring block is a left neighboring block.

16. The apparatus of claim 13, wherein the first syntax element is a single bit.

17. The apparatus of claim 13, wherein the second syntax element is coded using variable length coding.

18. The apparatus of claim 13, further comprising:
means for receiving a fourth syntax element indicating that refinements to main modes will not be signaled for video blocks of a series of video blocks.

19. A computer program product comprising a computer-readable storage medium having stored thereon instructions that, when executed, cause one or more processors of a device for decoding video data to:
identify a first prediction mode for a first neighboring block of the video block, wherein the first prediction mode is one of a set of prediction modes;
identify a second prediction mode for a second neighboring block of the video block, wherein the second prediction mode is one of the set of prediction modes;
based on the first prediction mode and the second prediction mode, identify a most probable prediction mode for the video block, wherein the most probable prediction mode is one of a set of main modes and the set of main modes is a sub-set of the set of prediction modes;
in response to receiving a first syntax element, generate a prediction block for the video using the most probable mode;
in response to receiving a second syntax element, identify an actual prediction mode for the video block based on a third syntax element and a fourth syntax element, wherein the third syntax element identifies a main mode and the fourth syntax element identifies a refinement to the main mode.

20. The computer program product of claim 19, wherein the first neighboring block is an upper neighboring block.

21. The computer program product of claim 19, wherein the second neighboring block is a left neighboring block.

22. The computer program product of claim 19, wherein the first syntax element is a single bit.

23. The computer program product of claim 19, wherein the second syntax element is coded using variable length coding.

24. The computer program product of claim 19, further comprising instructions that cause the one or more processors to receive a fourth syntax element indicating that refinements to main modes will not be signaled for video blocks of a series of video blocks.

25. A method of encoding a video block, the method comprising:
identifying a first prediction mode for a first neighboring block of the video block, wherein the first prediction mode is one of a set of prediction modes;
identifying a second prediction mode for a second neighboring block of the video block, wherein the second prediction mode is one of the set of prediction modes;
based on the first prediction mode and the second prediction mode, identifying a most probable prediction mode for the video block, wherein the most probable prediction mode is one of a set of main modes and the set of main modes is a sub-set of the set of prediction modes;
identifying an actual prediction mode for the video block;
in response to the actual prediction mode being the same as the most probable prediction mode, transmitting a first syntax element indicating that the actual mode is the same as the most probable mode;
in response to the actual mode not being the same as the most probable prediction mode, transmitting a second syntax element indicating a main mode and a third syntax element indicating a refinement to the main mode, wherein the main mode and the refinement to the main mode correspond to the actual prediction mode.

26. The method of claim 25, wherein the first neighboring block is an upper neighboring block.

27. The method of claim 25, wherein the second neighboring block is a left neighboring block.

28. The method of claim 25, wherein the first syntax element is a single bit.

29. The method of claim 25, wherein the second syntax element is coded using variable length coding.

30. The method of claim 25, further comprising:
transmitting a fourth syntax element indicating that refinements to main modes will not be signaled for video blocks of a series of video blocks.

31. A video encoder comprising:
a prediction unit to:
determine an actual prediction mode for a video block;
identify a first prediction mode for a first neighboring block of the video block, wherein the first prediction mode is one of a set of prediction modes;
identify a second prediction mode for a second neighboring block of the video block, wherein the second prediction mode is one of the set of prediction modes;
based on the first prediction mode and the second prediction mode, identify a most probable prediction mode for the video block, wherein the most probable prediction mode is one of a set of main modes and the set of main modes is a sub-set of the set of prediction modes;
in response to the actual prediction mode being the same as the most probable prediction mode, generating a first syntax element indicating that the actual mode is the same as the most probable mode;
in response to the actual mode not being the same as the most probable prediction mode, generating a second syntax element indicating a main mode and a third syntax element indicating a refinement to the main mode, wherein the main mode and the refinement to the main mode correspond to the actual prediction mode.

32. The video encoder of claim 31, wherein the first neighboring block is an upper neighboring block.

33. The video encoder of claim 31, wherein the second neighboring block is a left neighboring block.

34. The video encoder of claim 31, wherein the first syntax element is a single bit.

35. The video encoder of claim 31, wherein the second syntax element is coded using variable length coding.

36. The video encoder of claim 31, wherein the prediction encoding unit is further configured to generate a fourth syntax element indicating that refinements to main modes will not be signaled for video blocks of a series of video blocks.

37. An apparatus for encoding video data, the apparatus comprising:
means for identifying a first prediction mode for a first neighboring block of the video block, wherein the first prediction mode is one of a set of prediction modes;
means for identifying a second prediction mode for a second neighboring block of the video block, wherein the second prediction mode is one of the set of prediction modes;
means for identifying a most probable prediction mode for the video block based on the first prediction mode and the second prediction mode, wherein the most probable prediction mode is one of a set of main modes and the set of main modes is a sub-set of the set of prediction modes;
means for identifying an actual prediction mode for the video block;
means for transmitting a first syntax element indicating that the actual mode is the same as the most probable mode in response to the actual prediction mode being the same as the most probable prediction mode;
means for transmitting a second syntax element indicating a main mode and a third syntax element indicating a refinement to the main mode in response to the actual mode not being the same as the most probable prediction mode, wherein the main mode and the refinement to the main mode correspond to the actual prediction mode.

38. The apparatus of claim 37, wherein the first neighboring block is an upper neighboring block.

39. The apparatus of claim 37, wherein the second neighboring block is a left neighboring block.

40. The apparatus of claim 37, wherein the first syntax element is a single bit.

41. The apparatus of claim 37, wherein the second syntax element is coded using variable length coding.

42. The apparatus of claim 37, further comprising:
means for transmitting a fourth syntax element indicating that refinements to main modes will not be signaled for video blocks of a series of video blocks.

43. A computer program product comprising a computer-readable storage medium having stored thereon instructions that, when executed, cause one or more processors of a device for encoding video data to:
identify a first prediction mode for a first neighboring block of the video block, wherein the first prediction mode is one of a set of prediction modes;
identify a second prediction mode for a second neighboring block of the video block, wherein the second prediction mode is one of the set of prediction modes;
based on the first prediction mode and the second prediction mode, identify a most probable prediction mode for the video block, wherein the most probable prediction mode is one of a set of main modes and the set of main modes is a sub-set of the set of prediction modes;
identify an actual prediction mode for the video block;
in response to the actual prediction mode being the same as the most probable prediction mode, transmit a first syntax element indicating that the actual mode is the same as the most probable mode;
in response to the actual mode not being the same as the most probable prediction mode, transmit a second syntax element indicating a main mode and a third syntax element indicating a refinement to the main mode, wherein the main mode and the refinement to the main mode correspond to the actual prediction mode.

44. The computer program product of claim 43, wherein the first neighboring block is an upper neighboring block.

45. The computer program product of claim 43, wherein the second neighboring block is a left neighboring block.

46. The computer program product of claim 43, wherein the first syntax element is a single bit.

47. The computer program product of claim 43, wherein the second syntax element is coded using variable length coding.

48. The computer program product of claim 43, further comprising instructions that cause the one or more processors to transmit a fourth syntax element indicating that refinements to main modes will not be signaled for video blocks of a series of video blocks.
